(19) United States
(12) Patent Application Publication
(10) Pub. No.: US 2026/0312951 A1
(43) Pub. Date: Oct. 8, 2026

(54) SYSTEM AND METHOD FOR HIGHLY SECURE SHORT MESSAGE SERVICE (SMS) AND TIME-BASED ONE-TIME PASSWORDS (TOTP) SERVICES

(71) Applicant: BALDEV KRISHAN, Pleasanton, CA (US)

(72) Inventor: BALDEV KRISHAN, Pleasanton, CA (US)

(21) Appl. No.: 19/097,865

(22) Filed: Apr. 2, 2025

(51) Int. Cl. H04L 9/40

(52) U.S. Cl. CPC H04L 63/0838

(57) ABSTRACT

The present invention discloses a multi-factor authentication system that enhances the security of online services by integrating biometric authentication and contextual verification with traditional SMS-based One-Time Password (OTP) and Time-Based One-Time Password (TOTP) methods. The system requires the user to authenticate through biometric modalities such as fingerprint, facial recognition, iris detection or voice patterns before accessing the OTP/TOTP. Additionally, contextual data, including location, time, and device ID, is captured and verified to further secure the authentication process. The mobile application interacts with the service provider's backend server to request and verify OTP/TOTP codes, ensuring that only authorized users can access services. The system employs encryption and secure communication protocols to protect user data during transmission. By combining “what the user knows” (OTP/TOTP), “what the user has” (mobile device), and “who the user is” (biometric authentication), the invention strengthens authentication, reducing the risk of unauthorized access and enhancing overall security.

### FIELD OF THE INVENTION

The present invention relates to the field of digital authentication and security system, specifically to multifactor authentication (MFA) methods such as SMS-based one-time passwords (OTP) and time-based one-time passwords (TOTP) that enhances the security of user access to online services. More particularly, the invention provides a secure authentication solution by integrating biometric verification, device attributes, and contextual data (such as location and time) to prevent unauthorized access and mitigate common vulnerabilities associated with traditional authentication mechanisms.

### BACKGROUND OF THE INVENTION

When you sign into your online accounts-a process we call “authentication” occurs in which user proves to the service provider that you are who you say you are. Traditionally that's been done with a username and a password. Unfortunately, that's not a very good way to do it. Usernames are often easy to discover; sometimes they're just your email address. Since passwords can be hard to remember, people tend to pick simple ones, or use the same password at many different sites.

That's why almost all online services-banks, social media, financial transaction, and shopping-have added a way for your accounts to be more secure. You may hear it called “Two-Step Verification” or “Multifactor Authentication” but the good ones all operate on the same principle. When you sign into the account for the first time on a new device or app (like a web browser) you need more than just the username and password. You need a second verification method—what we call a second “factor”—to prove who you are. These second verification are also known as possession-based factors like one-time passwords (OTPs) delivered via SMS or generated through time-based one-time password (TOTP) applications such as Google Authenticator.

Among the most commonly used MFA methods are SMS-based authentication and time-based one time password (TOTP) authentication. These methods are widely deployed to safeguard user accounts, sensitive data, and financial transactions. However, despite their widespread adoption, both SMS and TOTP authentication have inherent security vulnerabilities that expose users to various cyber threats.

SMS-based authentication involves sending a one-time code to the user's registered mobile number or email address. The user must enter this code to verify their identity and gain access to the service. While SMS-based authentication is convenient and easy to deploy, it is susceptible to multiple security threats, including: Cyber threats in which criminals can fraudulently transfer a victim's phone number to another SIM card, allowing them to intercept the authentication codes and bypass security measures. Attackers often trick users into revealing SMS codes by impersonating legitimate entities through fraudulent messages or emails. SMS messages can be intercepted over unencrypted communication channels, exposing them to unauthorized access. If an unauthorized person gains physical access to a user's phone, they can retrieve SMS codes and gain unauthorized access to the associated service.

Moreover, the widespread reuse of usernames and passwords across multiple services exacerbates the risks associated with SMS authentication. Once an attacker obtains login credentials through data breaches or credential stuffing attacks, they can easily exploit SMS-based authentication to gain control over user accounts.

Additionally, TOTP authentication is a more secure alternative to SMS-based. authentication. It involves the generation of a time-sensitive one-time code both on the user's device (via an authenticator app) and the service provider's server. The user must enter the matching code to authenticate successfully. Despite being considered more secure than SMS authentication, TOTP also has several limitations, including: If the user's mobile device is lost, stolen, or compromised, the attacker can potentially access the TOTP app and retrieve authentication codes.

If an attacker gains access to the user's device (e.g., through physical theft or malware), they can potentially extract the TOTP codes, allowing them to bypass the authentication process.

Additionally, if the user's device is compromised, any stored authentication tokens can be stolen, giving the attacker the ability to authenticate without needing the user's physical presence.

Despite the use of SMS and TOTP for multifactor authentication, both methods are prone to significant security risks. The primary limitations include: Both SMS and TOTP rely on something the user possesses (a phone or device). If an attacker gains control of this possession (e.g., through SIM swapping, phishing, or device theft), they can easily bypass these authentication mechanisms. Users often recycle passwords and usernames across multiple services, making them more vulnerable to attacks. Once attackers gain access to the username and password, the presence of SMS or TOTP does not provide sufficient protection. Neither SMS nor TOTP considers the context of the authentication request (e.g., location, time, device), leaving the system blind to potentially suspicious login attempts from unrecognized or malicious sources.

Therefore, to solve the limitations associated with prior art the present invention discloses an advanced authentication system that integrates biometric verification and contextual security attributes, including location, time, and device identity to secure SMS and TOTP based authentication mechanism. The system protects against SIM swapping, phishing, and device theft by requiring biometric authentication before allowing access to sensitive authentication codes. Additionally, since the contextual attributes such as location and time are checked, unauthorized access from unexpected locations or devices can be blocked, even if the attacker has the correct authentication codes.

### OBJECTIVES OF THE INVENTION

A key objective of the present invention is to mitigate the security risk associated with SMS and TOTP based authentication, such as SIM swapping, device theft, and phishing, by integrating a stronger, multi-layered verification process that include biometric checks and contextual verification.

Another objective of the present invention is to provide an authentication system which enhance SMS-based authentication by routing OTP delivery through a secure mobile app that requires biometric authentication before revealing the code to eliminate the vulnerability associated with SIM swapping and message interception.

Another objective of the present invention is to prevent unauthorized access to online services by requiring biometric authentication before granting access to sensitive authentication codes (such as SMS, OTP, or TOTP), ensuring that only the legitimate user can access the authentication mechanism.

Another objective of the present invention is to provide real-time monitoring of authentication attempts based on contextual parameters and biometric verification, helping organizations to detect suspicious activities and respond promptly.

Another objective of the present invention is to assist organizations in meeting regulatory compliance requirements related to strong authentication practices by incorporating advanced security measures into existing authentication workflows. Further objectives, advantages, and features of the present invention will become apparent from the detailed description provided herein below, in which various features and functionalities of the disclosed invention are illustrated by way of the following examples.

### SUMMARY OF THE INVENTION

This summary is provided to introduce present invention in a simplified form that is further described below in the detailed description. This summary is not intended to identify key features or essential features of the claimed invention subject matter, nor is intended to be used as an aid in determining the scope of the claimed subject matter.

The present invention discloses a multifactor authentication system designed to provide secure authentication across various online services and platforms, leveraging the combination of biometric verification, contextual checks, and traditional authentication methods to prevent unauthorized access on a wide range of devices and services. The present system implements dynamic and real-time checks based on 35+ contextual data, ensuring that the system remains responsive to changing authentication conditions and can adjust its security posture in response to potential threats.

In other words, the advanced multi-factor authentication system of the present invention is designed to enhance the security of online services by integrating biometric authentication and contextual data with traditional authentication methods such as SMS and Time-Based One-Time Password (TOTP). The invention aims to address the security vulnerabilities associated with SMS and TOTP-based authentication by introducing additional layers of security, including biometric authentication and contextual verification. The present invention provide a novel approach to ensure that only authorized users can access services, even if authentication codes are compromised.

According to an embodiment of the present invention, the system comprises a mobile application installed on the user's mobile device, a service provider's backend server, and a communication network facilitating secure interactions between these components. The mobile application includes key functional modules such as a biometric authentication module, which verifies the user's identity through fingerprint or facial recognition, and a context authentication module, which captures and validates dynamic contextual data such as the user's location, time of access, and device ID. The system also integrates an application programming interface (API) that enables secure data exchange between the mobile application and the service provider's server, ensuring real-time authentication while maintaining user privacy and security.

In the case of SMS-based authentication, the service provider (such as Bank) where the user is required to access the service with multi-factor authentication sends a request to SMS service provider to send an encrypted SMS to a phone number associated with the mobile application. The mobile application receives the request from the SMS service provider. The mobile application authenticates the user with biometrics and captures other user data such as location, time, and device ID. This captures data can be verified on the mobile phone or send it to the server for verification. Once the user is verified with biometrics and/or other captured data, the SMS message is decrypted.

According to another embodiment of the present invention, the server generates one time password (OTP) via an SMS provider and transmits it securely to the mobile application. Before granting access to the OTP, the system prompts the user for biometric authentication. If the biometric authentication is successful, the OTP is decrypted and contextual data (such as location and device ID) is captured and sent to the server for verification. The server validates the received contextual data against pre-registered records, and if all criteria match, the user is granted access to the requested service. If any discrepancies are detected, access is denied, and the attempt is logged for security monitoring.

The process of TOTP-based multi-factor authentication begins when a user initiates a request for a TOTP code via the mobile application. Upon receiving the request, the mobile app first prompts the user for biometric verification—using methods such as fingerprint or facial recognition—to confirm that the request originates from the legitimate device owner. If the biometric check is successful, the app then gathers essential contextual data, including the device ID, current location, and timestamp, to further validate the authenticity of the access attempt.

After that, the mobile app utilizes a securely stored shared secret in combination with the current timestamp and the captured contextual data to generate a unique TOTP code that is only valid for a brief period (e.g., 30 seconds). This TOTP code is then both displayed to the user and transmitted to the authentication server for verification. The user manually enters the TOTP into the service provider's login interface, where the server compares the received code against the expected value calculated using the same shared secret and timestamp. Additionally, the server assesses the contextual data to ensure it aligns with predefined security parameters. If the TOTP and the contextual information are valid and within acceptable ranges, the user is granted access to the requested service; otherwise, access is denied and the attempt is logged for security monitoring.

The invention significantly strengthens authentication security by providing a multi-layered approach that combines “what the user knows” (OTP/TOTP), “what the user has” (mobile device), and “who the user is” (biometric authentication) with additional contextual verification. The incorporation of biometric authentication ensures that even if the mobile device is compromised, unauthorized access is prevented. Contextual verification further enhances security by detecting anomalies, such as attempts to access the service from unrecognized devices or locations.

The system works by requiring the user to authenticate biometrically before gaining access to sensitive information like SMS or TOTP codes. In addition, contextual data such as the user's location, time, and device ID is captured to add a further layer of security. This combination of biometric authentication and contextual validation ensures that access to the service is granted only if all the factors match, significantly reducing the risk of unauthorized access.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of example embodiments and are part of the specification. Together with the following description, these drawings demonstrate and explain various principles of the instant disclosure.

FIG. 1 is a block diagram illustrating the overall architecture of a multifactor authentication system designed to provide secure authentication across various online services and platforms according to an embodiment of the present invention.

FIG. 2 is a flow diagram illustrating the communication process between the mobile devices, mobile application, and service provider's server during an authentication request and response process via API calls according to another embodiment of the present invention.

FIG. 3 is a flow-chart illustrating the steps involved in SMS-based multi-factor authentication according to an exemplary embodiment of the present invention.

FIG. 4 is a flow-chart illustrating the steps involved in TOTP-based multi-factor authentication according to another exemplary embodiment of the present invention.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the instant disclosure covers all modifications, equivalents, and alternatives falling within the scope of the appended claims.

### DETAILED DESCRIPTION OF THE INVENTION

The present invention discloses an advanced authentication system designed to enhance the security of online services by integrating biometric authentication and contextual verification with traditional authentication methods such as one-time password (OTP) based short message service (SMS) and time-based one-time password (TOTP). The disclosed system improves security by ensuring that access to the authentication codes is granted only after successful biometric verification and contextual attribute validation, including location, time, and device ID.

As used herein, the term “biometric authentication” refers to the process of verifying a user's identity through unique physical or behavioral characteristics, including but not limited to fingerprint recognition, facial recognition, voice patterns, or iris scans.

As used herein, the term “contextual data” refers to information collected about the user's environment or circumstances during authentication, including but not limited to the user's geographic location, the time of access, the device identifier (device ID) of the mobile device used for authentication, and other 35+ dynamic contextual parameters.

As used herein, the term “One-Time Password (OTP)” refers to a password that is valid for only one authentication session or transaction, typically sent to the user's mobile device via short message service (SMS) to be used in the authentication process.

As used herein, the term “Time-Based One-Time Password (TOTP)” refers to a password that is valid for a specific time window, generated based on the current time and a shared secret key between the user and the service provider, often used in authentication systems as a dynamic security code.

As used herein, the term “mobile application” refers to a software application installed on a mobile device, which facilitates the authentication process by interacting with the service provider's backend server and performing biometric and contextual verification.

As used herein, the term “mobile device” refers to any portable electronic device, such as a smartphone, tablet, or desktop, capable of running a mobile application, capturing biometric data, and transmitting data securely to a server for authentication.

As used herein, the term “API (Application Programming Interface)” refers to a set of protocols and tools that allow communication between the mobile application and the service provider's backend server to request, transmit, and validate authentication data, such as OTP/TOTP, biometric data, and contextual information.

As used herein, the term “encrypted communication” refers to the process of securing transmitted data using encryption protocols, such as Secure Socket Layer (SSL) or Transport Layer Security (TLS), to ensure the confidentiality and integrity of the information exchanged between the mobile application and the service provider's server.

As used herein, the term “device identifier (device ID)” refers to a unique identifier associated with a user's mobile device, used in the authentication process to confirm that the authentication request originates from a registered and trusted device.

As used herein, the term “geofencing” refers to a location-based service that uses GPS or RFID technology to establish a virtual boundary around a geographic area, allowing the system to verify whether the user is within a designated trusted location during the authentication process.

As used herein, the term “contextual verification” refers to the process of verifying authentication by evaluating contextual data, such as the user's location, time of access, and device ID, to ensure that the authentication request aligns with expected patterns and authorized parameters.

As used herein, the term “authentication request” refers to a request initiated by the mobile application to the service provider's server to begin the authentication process, typically involving the retrieval of an SMS-based OTP or Time-based OTP (TOTP) for user verification.

As used herein, the term “authentication log” refers to a secure record maintained by the system that logs all authentication attempts, including successful and failed verifications, biometric results, contextual data, and OTP/TOTP usage, for auditing, security monitoring, and forensic analysis.

As used herein, the term “encryption” refers to the process of converting data into a coded format to prevent unauthorized access, ensuring that sensitive information, such as biometric data, OTPs, and contextual data, is protected during transmission.

As used herein, the term “anomaly detection” refers to the process of identifying unusual patterns or behaviors in the authentication request, such as accessing from an unrecognized device or location, which may indicate unauthorized access attempts.

As used herein, the term “service provider's server” refers to the backend server operated by the entity providing the online service, responsible for managing user authentication, generating OTP/TOTP codes, and validating authentication data received from the mobile application.

As used herein, the term “service” refers to any online platform, application, or system that requires user authentication to grant access to its resources or data, such as banking applications, social media platforms, or enterprise systems.

As used herein, the term “trusted device” refers to a mobile device that has been registered by the user and is recognized by the service provider's server for the purpose of validating authentication requests.

According to an embodiment of the present invention, the multi-factor authentication system comprises a mobile application (such as iVALT) installed on a mobile device owned by a user, wherein the mobile application serves as the primary interface for the authentication process and is responsible for initiating an authentication request, and receiving SMS based one-time password (OTP) and time-based one-time passwords (TOTP); a biometric authentication module configured to verifies the user's biometric identity locally on the mobile device before proceeding to the next authentication step; a context authentication module configured to capture and verifies 35+ dynamic contextual data including but not limited to user's location, time of access, and unique device identifier (device ID), wherein the said contextual data is transmitted to the service provider's server for additional verification, adding an extra layer of security to the authentication process; an application programming interface (API) to secure communication between the mobile application and the service provider's server, wherein the API handles request such as OTP retrieval, contextual data transmission, and authentication response management; a processing module to process authentication requests and responses within the mobile application by processing biometric input, decrypt received OTP, and other security checks before granting access; a server associated with service provider to host the authentication backend, which generates and transmits SMS based OTPs upon receiving an API request from the mobile application, and validates the received TOTP and contextual data against pre-stored user information in the database; a database to store user credential, biometric data (in encrypted form), contextual information, and authentication logs for audit purposes; a SMS centre to generate SMS-based OTP and time-based one time password (TOTP); and a communication network to encrypted data transmission between the user's mobile device and the service provider's server to ensure secure communication.

According to another embodiment of the present invention, the mobile application includes a multi-modal biometric authentication interface that enables the user to choose between different biometric methods (fingerprint, facial recognition, or voice recognition) depending on the device's capabilities.

According to another embodiment of the present invention, the validation module in the backend server performs a comparison of received contextual data. (including location, time, and device ID) with expected patterns or predefined criteria and grants access if all verification factors match, and denies access if any factor is inconsistent.

According to another embodiment of the present invention, wherein the mobile application is further configured to: a. initiate an API call to the service provider's backend server to retrieve an OTP or TOTP for user authentication; b. require biometric authentication before the OTP/TOTP is displayed or used for access; and c. capture and transmit contextual data, including the user's location, time of access, and device ID, to the backend server for verification prior to granting access.

According to another embodiment of the present invention, the mobile application also includes a logging module to store and track authentication attempts, including successful and failed verification outcomes, biometric authentication results, and contextual verification data for security monitoring, auditing, and forensic analysis. The mobile application also stores a shared secret key for TOTP generation and, upon user registration with the service provider, securely receives and stores the key for subsequent authentication attempts.

According to another embodiment of the present invention, the service provider's backend server further includes a compliance and reporting engine configured to log all authentication activities for auditing purposes, including both successful and failed attempts, and generate alerts in case of suspicious activities or anomalies detected in the authentication process.

According to another embodiment of the present invention, authentication engine is further configured to perform one or more checks based on predefined security policies, including:
Geo-fencing, to detect whether the user's location is within a trusted region;
Device fingerprinting, to verify the authenticity of the device used for the authentication request; and
Time-window validation, to ensure the authentication attempt is made within an acceptable timeframe.

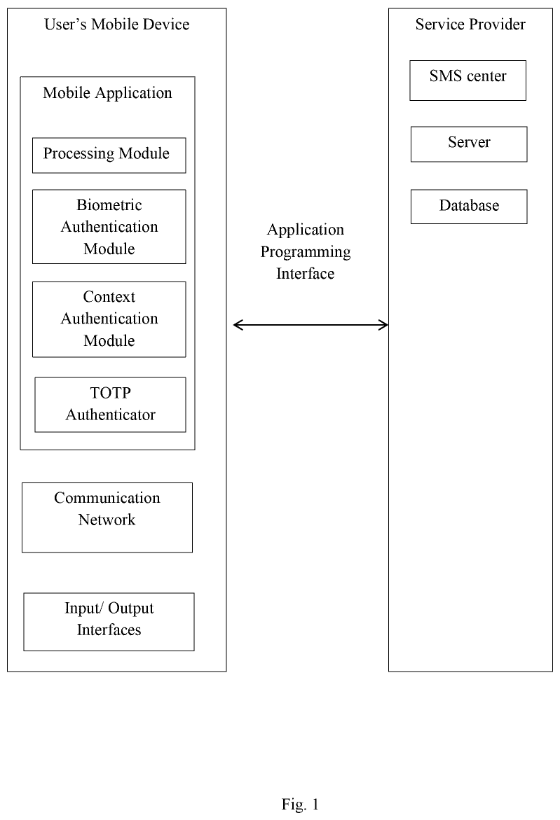

The following will provide, with reference to FIGS. 1-4, detailed description of an example system and method for multi-factor authentication that enhances the security of online service by integrating biometric authentication and contextual verification with traditional authentication methods such as SMS based one-time passwords (OTP) and Time-Based One-Time Passwords (TOTP).

Referring to FIG. 1, the system comprises a mobile application installed on a user's mobile device, which interacts with a service provider's server via secure communication channels. The mobile application includes various modules such as a biometric authentication module for verifying the user's identity through fingerprint or facial recognition, and a contextual authentication module for capturing critical parameters such as the user's location, time of access, and device ID. The system further incorporates an application programming interface (API) that facilitates secure communication between the mobile application and the service provider's backend, which includes a processing module and a database for storing authentication-related data.

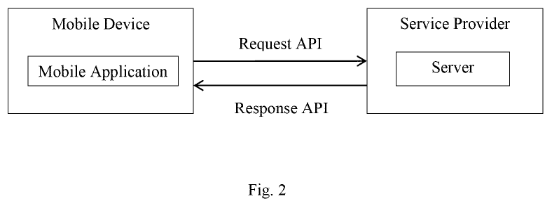

The method for initiating an API calls to receive SMS based OTP from the service provided is shown in FIG. 2. The said API call initiates from mobile application (such as iVALT) downloaded on a mobile device owned by a user. The mobile application sent an API call to an API endpoint on an external server located at the sight of service provider. The server API authenticates the call and grants access to the SMS centre to generate unique code in response to the initiated API request. The generated code is sent the user's application by the server through API response.

According to another embodiment, the present invention discloses a method for authenticating a text message comprising a unique SMS or TOTP code to access various online services provided by service provider, the method comprises the following steps: The user initiates an authentication request via a mobile application (such as iVALT) installed on their mobile device. The mobile application sends an API request to the service provider's external server to retrieve an SMS-based one-time password (OTP) or Time based one-time password (TOTP). Upon receiving the API request, the service provider's server generates a unique OTP or TOTP and transmits it securely to the mobile application via an encrypted API response. When the user attempts to access to OTP, the mobile application prompts user to perform biometric authentication using fingerprint recognition, facial recognition, and other biometric modality. The mobile application verifies the biometric data against stored credentials. If the authentication is successful, the app allows further processing; otherwise, access to the OTP is denied. Upon successful biometric authentication, the mobile application automatically captures contextual attributes, including the user's geographical location, the exact timestamp of access, and the unique device identifier (device ID). These attributes are securely packaged and transmitted to the service provider's server for validation. The contextual data, along with the decrypted OTP, is transmitted to the service provider's server, where it is compared with pre-registered user information and expected patterns to detect anomalies or suspicious activity. The server performs a multi-layered verification process by validating the received contextual parameters (location, time, device ID) against known user data. If the received data aligns with expected values, access to the requested service is granted; otherwise, the request is flagged or denied. If all authentication factors—biometric verification, contextual data, and the OTP—are successfully validated, the user is granted access to the intended online service. If any attribute fails verification, access is denied, and appropriate alerts may be generated for further action.

According to another embodiment of the present invention, the multi-factor authentication system logs all authentication attempts including successful and failed verifications, biometric authentication results, and contextual data for security monitoring, compliance, and forensic analysis in case of security incidents.

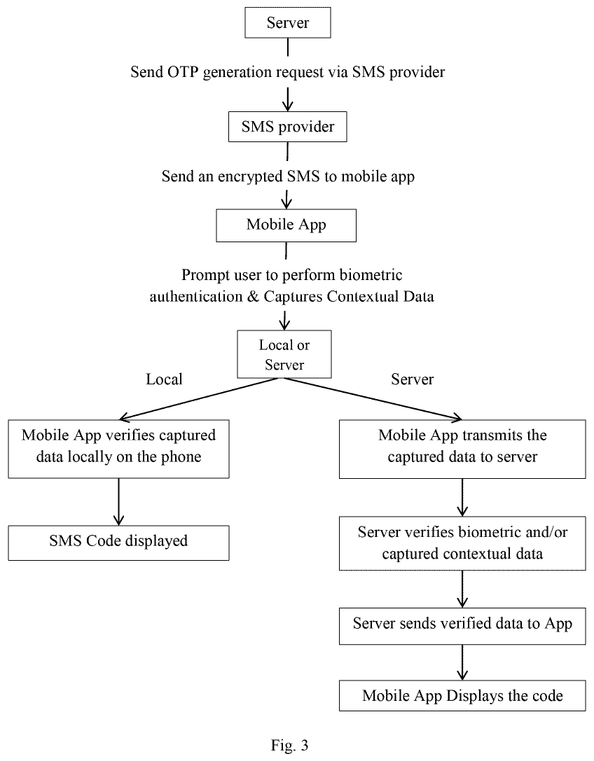

Referring now to FIG. 3 illustrating the steps involved in SMS-based authentication using OTP and biometric verification according to an exemplary embodiment of the present invention. When a user wants to access any service provided by a service provider's such as a bank, government portal, or any other secure application. The service provider requires the user to authenticate using multi-factor authentication (MFA). The process of multi-factor authentication initiates when a service provider's system or server sends an OTP generation request to an SMS provider. The SMS provider encrypts the OTP and sends it as an encrypted SMS to a phone number associated with the user's mobile application. Once the mobile application receives the encrypted SMS, it refrains from immediately displaying or processing the message. Instead, the app initiates a secondary authentication process that enhances security by combining biometric verification with contextual data capture. During this process, the user is first prompted to verify their identity through biometric methods such as fingerprint or facial recognition, ensuring that only the legitimate user can proceed. At the same time, the app captures essential contextual data—such as the user's current location, the exact time of the access request, and the unique device identifier—which serves as an additional layer of security. The captures biometric and contextual data is then verified either locally within the app using pre-stored trusted parameters or remotely by sending it to the server for validation against pre-registered records.

If the verification is performed locally, the mobile application compares the captured biometric and contextual data with pre-stored trusted parameters on the device. If the authentication is successful, the application decrypts the SMS and displays the OTP to the user, allowing them to enter it into the service provider's system for final authentication. In case of a failed biometric verification or mismatch in contextual data, access to the OTP is denied, and the authentication attempt may be logged or flagged for security monitoring.

Alternatively, if the verification is performed server-side, the captured biometric and contextual data is transmitted securely to the service provider's authentication server. The server then cross-checks this information against the user's pre-registered biometric profile, device details, and location history to confirm authenticity. If all parameters match, the server sends a response to the mobile application, allowing it to decrypt and display the OTP for the user. However, if any discrepancy is detected—such as an unrecognized device, unusual location, or biometric mismatch—the server may block access, deny OTP retrieval, and log the attempt for further analysis. This ensures an added layer of protection against fraudulent access attempts while maintaining a seamless user experience.

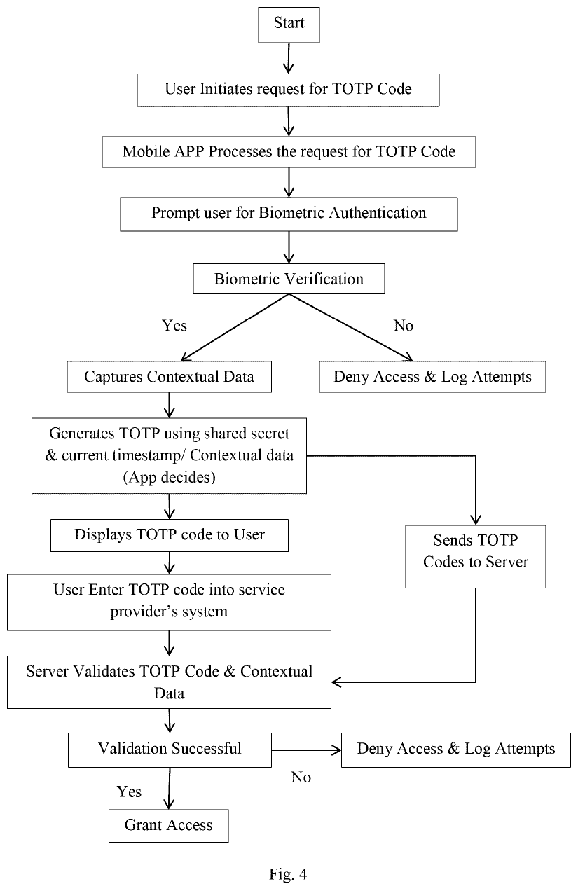

Referring now to FIG. 4 illustrating the steps involved in TOTP based multi-factor authentication according to another exemplary embodiment of the present invention. The process of a TOTP based multi-factor authentication begins when a user initiates request for TOTP Code via a mobile application. The mobile application receives the user's request and prepares to generate the TOTP. However, before generating the code, it ensures that the request is coming from the legitimate user. To verify the user's identity, the mobile app prompts for a biometric check (for example, fingerprint or facial recognition). This step ensures that only the rightful owner of the device can proceed. If the user passes the biometric verification, the process continues. If the user fails or cancels the biometric check, access is immediately denied and the attempt is logged for security monitoring. Once the user is successfully verified biometrically, the mobile app gathers contextual information such as device ID, location, and timestamp. This data provides an additional security layer by ensuring the request matches expected usage patterns or known trusted environments. The mobile app uses its securely stored secret key in combination with the current time stamp & contextual data to generate the TOTP code. This ensures that the code is unique for a short validity period (e.g., 30 seconds). After generation, the mobile app displays the TOTP code to the user and transmits it to the server for verification as shown in FIG. 4. The user then manually enters this code into the service provider's login interface or wherever the code is required. The TOTP is sent from the user (through manual entry) to the server or system that requires authentication. The server checks whether the received TOTP matches the expected value (calculated using the same shared secret and timestamp) and also evaluates any contextual data received. If both the TOTP and contextual details (e.g., device location) are valid and within acceptable parameters, the user is considered authenticated. If all checks pass, the user is granted access to the requested service. If any discrepancy is found—either in the TOTP code or in the contextual data—access is denied and the event is logged for security purposes.

I/We claim,

1. A multi-factor authentication system to access online service provided by a service provider, the system comprises:
a. a mobile application installed on a user's mobile device, configured to initiates an authentication request and facilitate the authentication process;
b. a biometric authentication module configured to verify the user's biometric identity;
c. a context authentication module configured to capture and verify multiple contextual parameters;
d. an application programming interface (API) configured to securely transmit authentication requests and contextual data between the mobile application and the service provider's backend server;
e. a processing module to process authentication requests and responses by verifying biometric input, decrypting received OTPs, and performing security checks before granting access;
f. a server associated with service provider to host the authentication backend, which generates and transmits SMS based OTP/TOTPs upon receiving an API request from the mobile application, and validates the received OTP/TOTP, biometric data, and contextual data against pre-stored user information in the database;
g. a database to store user credentials, including the biometric data (in encrypted form), contextual data, user credentials, and authentication logs for security auditing; and
h. a communication network configured to securely transmit encrypted authentication data between the user's mobile device and the service provider's server.

2. The multi-factor authentication system as claimed in claim 1, wherein the mobile application includes a multi-modal biometric authentication interface that enables the user to choose between different biometric methods (fingerprint, facial recognition, or voice recognition) depending on the device's capabilities.

3. The multi-factor authentication system as claimed in claim 1, wherein the secure communication interface utilizes encryption protocols, including at least one of Secure Socket Layer (SSL), Transport Layer Security (TLS), or other cryptographic methods, to secure data exchange between the mobile application and the service provider's backend server.

4. The multi-factor authentication system as claimed in claim 1, wherein the backend server performs a comparison of received contextual data including but not limited to location, time, and device ID with expected patterns or predefined criteria and grants access if all verification factors match, and denies access if any factor is inconsistent.

5. The multi-factor authentication system as claimed in claim 1, wherein the mobile application also includes a logging module to store and track authentication attempts, including successful and failed verification outcomes, biometric authentication results, and contextual verification data for security monitoring, auditing, and forensic analysis.

6. The multi-factor authentication system as claimed in claim 1, wherein the service provider's backend server includes a compliance and reporting engine configured to log all authentication activities for auditing purposes, including both successful and failed attempts, and generate alerts in case of suspicious activities or anomalies detected in the authentication process.

7. A method for multi-factor authentication using OTP and biometric verification, comprising the steps of:
a. receiving, by a mobile application, an OTP sent via encrypted SMS from a service provider's server;
b. prompting the user to perform biometric authentication before accessing the OTP;
c. capturing, by the mobile application, contextual data including the user's location, time of access, and device ID;
d. verifying, locally or remotely, the biometric and contextual data before granting access to the OTP;
e. decrypting the OTP only upon successful biometric and contextual verification;
f. allowing the user to enter the OTP into the service provider's system for final authentication;
g. blocking access and logging the authentication attempt if any of the biometric, contextual, or OTP verifications fail.

8. A method for time-based one-time password (TOTP) authentication using biometric and contextual verification, comprising:
a. initiating, by a mobile application, a request for TOTP generation;
b. prompting the user to perform biometric authentication before generating the TOTP;
c. capturing, by the mobile application, contextual data including device ID, location, and timestamp;
d. generating the TOTP using a securely stored secret key and the current timestamp;
e. displaying the generated TOTP to the user and transmitting it to the service provider's server for verification;
f. comparing the received TOTP with an expected value generated by the service provider's server using the same shared secret key and timestamp;
g. validating contextual data against pre-registered user information to confirm the authenticity of the request;
h. granting access to the requested service if both TOTP and contextual verification pass, otherwise denying access and logging the attempt.

9. The method as claimed in claim 7 or 8, wherein the step of prompting the user for biometric authentication further comprises: Requesting the user to perform at least one of: fingerprint authentication; facial recognition; voice pattern recognition; and iris recognition.

10. The method as claimed in claim 7 or 8, wherein the step of capturing contextual data further includes: capturing geo-location data indicating the user's location at the time of authentication; capturing a time-stamp to ensure the authentication occurs within an acceptable time window; and capturing a device identifier to confirm that the authentication request is originating from a registered device.

11. The method as claimed in claim 7 or 8, wherein the verification of the captured contextual data is performed either locally within the mobile application or remotely by the backend server.

12. The method as claimed in claim 7 or 8, wherein the step of validating the received contextual data, OTP/TOTP, and biometric information comprises:
a. comparing the received contextual data (location, time, and device ID) with predefined expected patterns stored on the service provider's backend server;
b. comparing the OTP/TOTP with the authentication code generated and stored by the service provider; and
c. verifying the biometric data against the stored biometric information in encrypted form.
